(19) United States
(12) Patent Application Publication
(10) Pub. No.: US 2004/0186795 A1
(43) Pub. Date: Sep. 23, 2004

(54) Liquid product distribution management

(76) Inventors: John A. Taylor SR., Winston-Salem, NC (US); Barry Swedeen, Winston-Salem, NC (US)

Correspondence Address: PILLSBURY WINTHROP, LLP, P.O. BOX 10500, MCLEAN, VA, 22102, US

(21) Appl. No.: 10/393,025

(22) Filed: Mar. 21, 2003

(51) Int. Cl. G06F 17/60

(52) U.S. Cl. 705/29

(57) ABSTRACT

An arrangement is provided for liquid product distribution management. Liquid product distribution information is collected from a plurality of liquid product terminals, wherein the liquid product distribution information includes receiving and lifting information associated with individual liquid product terminals. The lifting information includes meter additive readings that is indicative of the additive treat rates of the lifted product. Transactions are analyzed based on the liquid product distribution information from the liquid product terminals. Liquid product inventory balance projection and product scheduling forecast are automatically performed. Transactional and management reports are accordingly generated.

### BACKGROUND

Inventory management applies to managing product supply streamlines between suppliers and customers. In a product supply stream, a manufacturer may supply a certain product to a customer over a period of time through multiple shipments. In this context, good inventory management maintains a continuous product supply from relevant manufacturers to customers. An inventory management system may keep track of certain products that are in stock, including the stock in transit, observe the customer's consumption rate, and place orders to suppliers for more product shipment (replenishment) based on the dynamics related to both the inventory and the consumption rate.

To perform inventory management in a cost effective manner, various techniques are traditionally used to optimize underlying management strategies. For example, a desired level of inventory or inventory target at a customer site for a future period of time (e.g., a week) may be proactively estimated according to dynamics such as the projected customer consumption rate in the same period of time, estimated based on some past consumption rate, and the current inventory level at the customer site, computed based on the amount of products both in stock and in transit. Such an inventory target may be estimated with respect to each distinct customer site against each product and its corresponding supplier(s). Such an inventory target may then be used in scheduling shipment of the optimized amount of product from corresponding supplier(s) to the customer site.

Customers or purchasers in most supply streams do not further distribute products. However, with the increasingly complex product distribution networks, many products are not distributed directly to end customers. For example, a wholesale business may purchase products from manufacturers and then sell such products to its customers (end customers). A franchise may distribute goods to centralized warehouses for different geographical regions, which then distribute such goods to individual stores in their own regions that sell to end customers. In such product distribution networks, to carry out inventory management for the party that is in between a supplier and an end customer (e.g., the wholesale business or the centralized warehouses), the dynamics of both a supplier and an end customer may have to be modeled.

For certain types of products (perishables, hard to handle, difficulty measuring, etc.) there are product specific or product type specific problems that must be addressed to properly carry out product distribution management. For liquid products, there are special aspects to distribution and inventory management that make it impossible to use conventional inventory management systems. For example, certain liquid products such as petroleum are shipped in a raw form to, for example, a certain distribution site. The distribution site refines the raw product and delivers the refined product to its customers. Refinement may be carried out at the distribution site according to customers' needs. For example, a distribution site for petroleum based products may store raw petroleum shipped to it from suppliers. It may be equipped to process raw petroleum in its storage tanks to produce, e.g., Brand A Premium grade gasoline or Brand B regular grade gasoline. A customer may specify the product needed and the distribution site then carries out an additive and/or blending process appropriate to mix the desired product before it distributes refined product to the customer.

In such a liquid product distribution network, product(s) shipped to the distribution site is not the same as product(s) distributed to end customers. The inventory management system at the distribution site must accommodate certain raw and blended products. There are other challenges specific to inventory management of petroleum liquid products. For example, petroleum based products are often regulated by various government agencies (e.g., federal, state, county, local). Management at a petroleum product distribution site may be required to have the capability of automatically enforcing governmental regulations and capturing sufficient transactional data related to and during product blending/mixing and distribution.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar parts throughout the several views of the drawings, and wherein:

FIG. 1 schematically depicts an exemplary framework for liquid product distribution and management, according to an embodiment of the inventions;

FIG. 2 schematically depicts an exemplary internal functional block diagram of a liquid product distribution terminal, according to an embodiment of the inventions;

FIG. 3 illustrates an exemplary construct of lifting information, according to an embodiment of the inventions;

FIG. 4 schematically depicts an exemplary internal functional block diagram of a terminal report generation mechanism, according to an embodiment of the inventions;

FIG. 5 illustrates an exemplary construct of a common carrier receiving report, according to an embodiment of the inventions;

FIG. 6 schematically depicts an exemplary internal functional block diagram of a liquid product management mechanism, according to an embodiment of the inventions;

FIG. 7(a) provides an illustrative user interface for activating different types of information processing, according to an embodiment of the inventions;

FIG. 7(b) provides an illustrative user interface for activating generation of different types of report, according to an embodiment of the inventions;

FIG. 7(c) provides an illustrative user interface for making adjustment to supplier daily inventories, according to an embodiment of the inventions;

FIG. 7(d) provides an illustrative user interface for activating generation of reports for different governmental agencies, according to an embodiment of the inventions;

FIG. 7(e) provides an illustrative user interface for activating various terminal management tasks, according to an embodiment of the inventions;

FIG. 8 is a flowchart of an exemplary process, in which a liquid product distribution network is automatically managed, according to an embodiment of the inventions;

FIG. 9 is a flowchart of an exemplary process, in which a terminal report generation mechanism of an LPDT generates various terminal reports, according to an embodiment of the inventions;

FIG. 10 is a flowchart of an exemplary process, in which liquid product distribution projection and liquid product scheduling forecast are performed, according to an embodiment of the inventions;

FIG. 11 is a flowchart of an exemplary process, in which the report generation mechanism 625 of the liquid product management mechanism 120 generates different reports, according to an embodiment of the inventions; and

FIG. 12 schematically depicts an exemplary web-based architecture for liquid product distribution and automated management, according to an embodiment of the inventions.

### DETAILED DESCRIPTION

The process described below may be performed by a properly programmed general purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

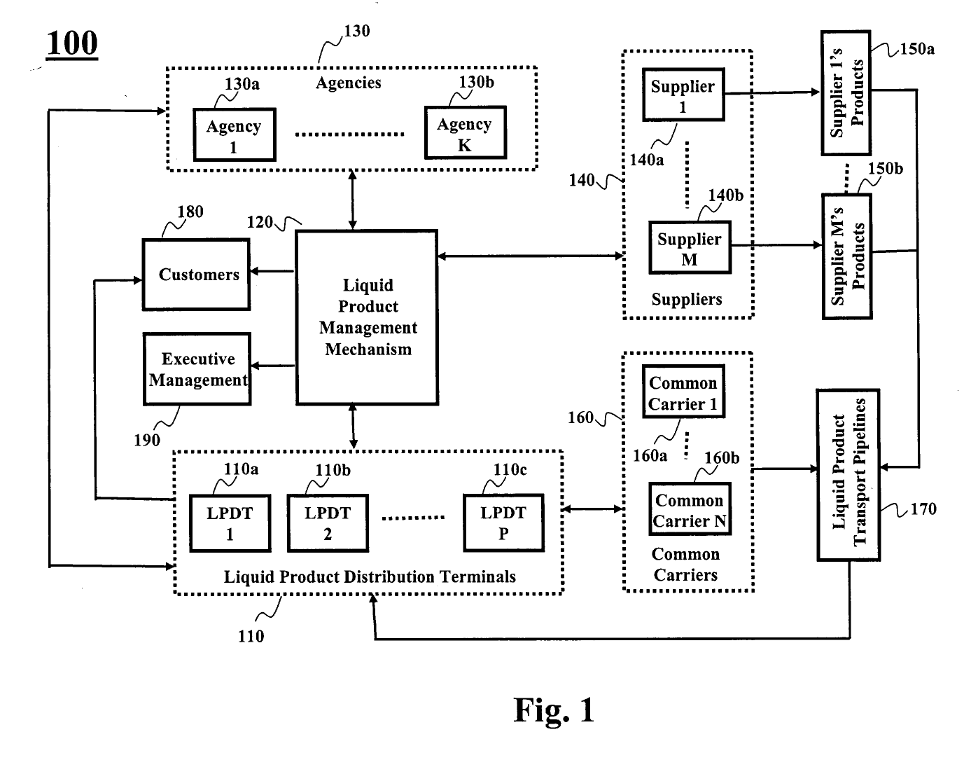

FIG. 1 schematically depicts an exemplary framework 100 for liquid product distribution and management, according to an embodiment of the inventions described herein. The liquid product distribution and management framework 100 includes a plurality of liquid product distribution terminals 110, a liquid product management mechanism 120, one or more suppliers 140, one or more common carriers 160, and a plurality of customers 180. The suppliers 140 may include a supplier 1-M (140a, . . . 140b). Each supplier may offer one or more liquid products (e.g., the supplier 1 140a offers products 150a, . . . , the supplier M offers liquid products 150b). A liquid product may include, but is not limited to, petroleum. It is possible that different suppliers may provide the same kind of liquid products. For example, it is possible to obtain a liquid product A from suppliers 1 and 7 and liquid product B from suppliers 7 and 9.

The liquid product distribution terminals 110 includes a liquid product distribution terminal (LPDT) 1 (110a), a LPDT 2 (110b), . . . , and a LPDT p (110c), each of which is capable of storing products from one or more suppliers and subsequently distributing such liquid products to one or more customers. Each LPDT may store certain types of liquid products offered by certain suppliers. Liquid products offered by different suppliers may be delivered to LPDTs through one or more common carriers (e.g., a common carrier 1 160a, . . . , a common carrier N 160b) or other transportation means.

The LPDTs are set up to provide so-called “terminalling services”. The LPDTs are used to store products needed by the customers 180. Each LPDT then distributes its stored liquid products to appropriate customers. According to the flow of the products, the products are replenished as needed based on the actual rate of the flow. The distribution chain from the suppliers 140 to customers 180 includes from the suppliers 140 to the common carriers 160, from the common carriers 160 to the LPDTs 110, and from the LPDTs 110 to the customers 180.

Between the suppliers 140 and the common carriers 160, there may be liquid product transport pipelines 170, through which the suppliers 140 transport their products to the common carriers 160. Via the liquid product transport pipelines 170, liquid products (150a, . . . 150b) are delivered to different LPDTs. Between the LPDTs 110 and the customers 180, desired product(s) may be lifted from the LPDTs and shipped to the customers 180. This framework 100 allows for a variety of so-called “lifting” scenarios. For example, a customer may arrive at a LPDT to lift the desired product(s). In a different scenario, a customer may contract with a service provider to lift and deliver desired product(s).

A customer may be any customer to whom liquid products are distributed according to demand or contractual terms. A customer may include a supplier's customer. Depending on the needs of customers and their geographical locations, a single LPDT may distribute its stored liquid product(s) to a plurality of customers. It is also possible that a customer needing multiple liquid products may obtain needed products from more than one LPDT.

At each LPDT, there may be a plurality of tanks used to store liquid products. Each tank may be equipped to facilitate various tasks. For example, each tank may be capable of providing various readings such as total capacity of the tank, the current level of storage, type of product currently stored, the temperature and the specific gravity of the tank, etc. Each tank may also provide mechanisms through which different tasks may be performed. For instance, appropriate mechanisms may be used to enable a common carrier to download liquid product from a truck into a tank. Such a mechanism may further furnish dynamic measures related to the product in the tank.

Other mechanisms associated with a tank may also be provided that enable a customer (or its service provider) to lift liquid product from the tank. For instance, certain interfaces may be set up so that a customer can specify the amount of a liquid product to be lifted. Others may include the facilities through which a customer may specify, for example, a desired grade of a particular product, based on which different base products are blended together to produce product of desired grade based on the stored product. Product additives may also be used and stored in separate tanks and managed by framework 100. Even though a particular formulation of an additive may be unknown (perhaps proprietary) in framework 100, the additive can be stored and any liquid product can be treated by the additive according to a specification provided by the supplier of the additive. For example, petroleum company X may have a proprietary additive A that is added to a gasoline product at different treat rates for different grades of its branded gasoline (e.g., premium, special, and standard). A tank mechanism may be capable of securely storing such proprietary information associated with different suppliers and applying different pieces of information based on needs.

In addition to be able to applying different pieces of proprietary information in a particular lifting, a LPDT may also be equipped with hardware and information processing technology to enable it to enforce various government regulations during a lifting process. Therefore, framework 100 may further comprise one or more governmental agencies (an agency 1 130a, . . . , an agency K 130b) which regulate various aspects of the distribution of liquid products that are distributed by the LPDTs 110. There may be many different governmental agencies involved, each with its own set of regulations that must be enforced. For example, the federal government may require that all grades of gasoline have a minimum rate of certain additives. Hardware and information processing technology is provided to monitor rates of additives and make certain that the additives are utilized in accordance with the government requirements.

Each LPDT may be also be equipped to capture and furnish additional information. For example, a LPDT may provide a measure known as “tank bottom” to indicate the lowest level in the tank at which liquid product can be lifted. A measure of tank bottom 20% indicates an effective storage capacity of the tank to be 80% with the bottom 20% in the tank not being available for distribution to customers. For instance, the bottom 20% of a tank may be below the pipe flange or may not be physically possible to remove or can not be removed due to governmental regulations such as the product below the level at which a floating roof will float on gasoline. As another example, an additive meter reading may also be provided to allow an operator to discern the additive rate injected into lifted product. Furthermore, measures related to, for instance, daily liftings or daily additive meter readings may also be furnished at each tank.

Daily readings of data from each LPDT provide management information related to the distribution of the stored liquid products. Such data may be used by LPDT management to derive statistics related to business operations. For example, an LPDT manager may obtain distribution data with respect to each product and each customer. Such data may be later used for various purposes including billing and projecting the future replenishment of different products. Tank readings may also provide useful information to be used to generate various reports required by government agencies to track and/or enforce their respective regulations. Some data gathering and processing tasks may be performed locally by the LPDTs and some of them may be performed in a centralized fashion by the liquid product management mechanism 120.

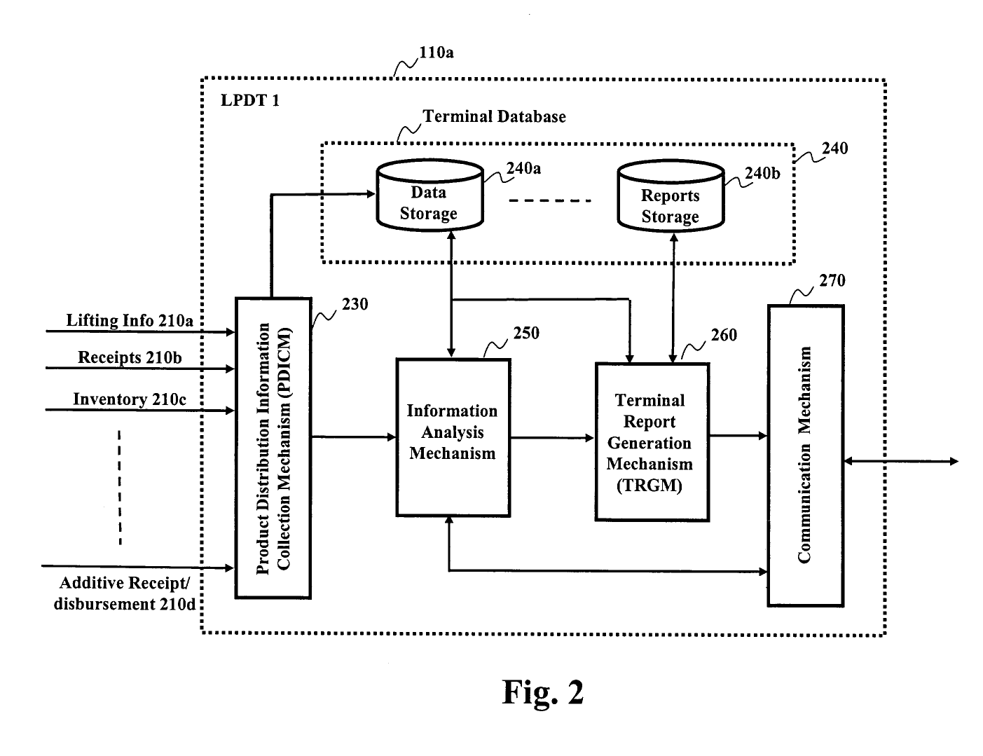

Based on tank readings and other operational information, an LPDT may locally perform various management related tasks. For example, an LPDT may perform certain analysis on the tank readings so that appropriate reports can be generated to summarize different aspects of the operations at the LPDT. Such reports may include, but are not limited to, a receipt report, a lifting report, an inventory report, a product balance report, a supplier balance report, or a bill of lading report (a legal document recording the particular lifting of a product). The LPDT may be capable of communicating with other parties such as the liquid product management mechanism 120, the common carriers 160, and possibly different governmental agencies 130. Such communications may be conducted through a generic network such as a PSTN, an intranet, the Internet, a proprietary network, or a wireless network. During such communications, the LPDT may send to, receive from, or exchange information with the parties in communication. Details about an individual LPDT are described with reference to FIGS. 2-5.

The liquid product management mechanism 120 may be operating from a different physical location than the LPDTs. It may interact with the LPDTs 110 through communication connections. Such communication connections may be made through a generic network, which includes, but is not limited to, a public switched telephone network (PSTN), intranet network, the Internet, proprietary network, or a wireless network. The liquid product management mechanism 120 may be responsible for performing a plurality of centralized tasks. Such tasks may be carried out based on data gathered from the LPDTs 110.

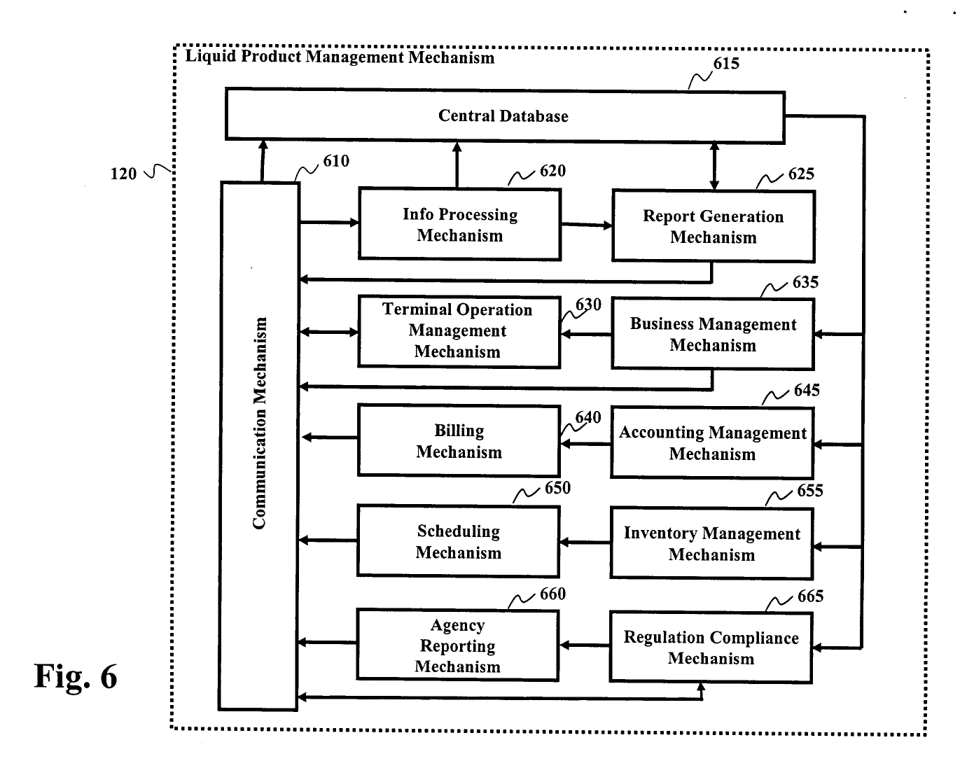

The liquid product management mechanism 120 may collect daily (or some other frequency) product distribution information from the LPDTs. Analysis may be performed using the collected information. Using analyzed results, the liquid product management mechanism 120 may generate reports summarizing various aspects of the business operations at LPDTs and send such reports to, for example, management executives of the company (represented by executive management 190). The liquid product management mechanism 120 may also carry out billing tasks on a regular basis based on the information collected from LPDTs. In addition, the liquid product management mechanism 120 may also perform distribution projection based on lifting information. Such projection may be further used to forecast the liquid product scheduling so that the inventory is maintained at a desirable level with respect to the projected distribution. Details about the liquid product management mechanism 120 are described with reference to FIGS. 6, 10, and 11.

FIG. 2 schematically depicts an exemplary functional block diagram of an LPDT (e.g., the LPDT 1 110a), according to an embodiment of the inventions. The LPDT 1 110a includes a product distribution information collection mechanism (PDICM) 230, a terminal database 240, an information analysis mechanism 250, a terminal report generation mechanism (TRGM) 260, and a communication mechanism 270. The PDICM 230 gathers information from different sources. For example, it may receive information related to lifting (210a), receipts (210b), inventory (210c), additive receipt/disbursement (210d), or regulations of different governmental agencies (see FIG. 1). Such gathered information may be stored in data storage 240a in the terminal database 240. Such gathered information may also be directly fed to the information analysis mechanism 250 for further analysis.

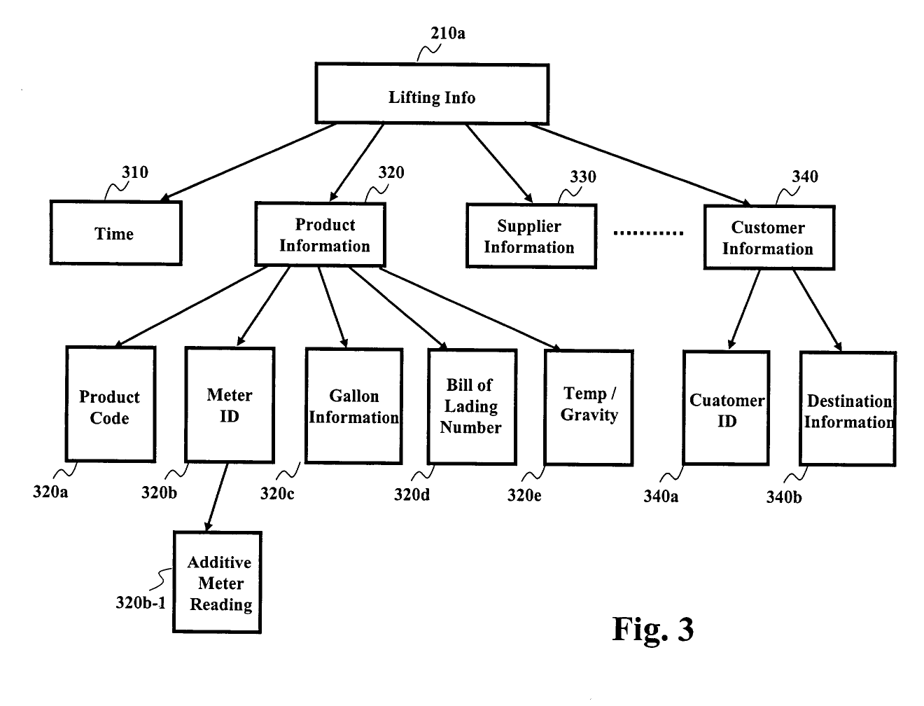

FIG. 3 illustrates an exemplary construct of lifting information 210a, according to an embodiment of the inventions. Each lifting corresponds to a transaction. Therefore, information related to a particular lifting event may be used to describe the underlying transaction. Lifting information 210a includes various categories of information such as a recorded time of the lifting (310), information related to the lifted product (320), information related to the supplier of the lifted product (330), . . . , and information related to the customer who lifted the product (340).

Each category may include more detailed data related to the lifting. For instance, within the category of product information 320, there may be a product code 320a (e.g., entered by a customer's transport carrier to identify the lifted product), a meter identification (ID) 320b (e.g., to identify the meter associated with the tank from where the product is lifted), gallon information 320c (e.g., to indicate the amount of product lifted), a bill of lading number 320d, and other data associated with the tank such as product temperature and specific gravity. As used herein, “gravity” is the density of a liquid product relative to that of water (temperature and gravity are used in volumetric calculations to adjust gross gallon inventory to an industry-standard, e.g., 60° reference). Customer information 340 may include a customer identification 340a (e.g., entered by the customer who lifted the product) and destination information 340b (e.g., a description of the destination to where the lifted product is delivered). In addition, the identified meter may provide additive meter readings (320b-1) indicative of relevant additive treat rates associated with the lifting. Such additive treat rates may identify the refined product resulted from the lifting and may be enforced according to certain requirements specified by, for example, federal target liquid additive calculations.

The terminal database 240 (FIG. 2) may include different storages, each of which may be designated for a particular purpose. For example, the terminal database 240 may comprise a data storage 240a, designated to store information gathered from different LPDTs, and a report storage, designated to store various reports generated based on the information from the LPDTs. The terminal database 240 may be realized using available techniques or commercial products. For example, the terminal database 240 may be implemented using commercially available database systems such as Structured Query Language (SQL), Oracle, DB2, Sybase, or Access, or any other suitable database management arrangement. The terminal database 240 may also simply correspond to a data depository mechanism implemented using other known techniques such as spreadsheets, or the like.

Different storages within the terminal database 240 may be implemented using the same or different techniques. For example, the data storage 240a may be realized using spreadsheets and the reports storage 240b may be implemented using conventional database techniques. In addition, these different storages may reside on the same or different physical devices. For instance, spreadsheets may reside on a personal computer that is linked to all tanks directly to obtain different readings. At the same time, the reports generated by the underlying LPDT may be stored and managed on a separate SQL server. In this case, the data storage 240a resides in the PC and the reports storage resides in the SQL server. Depending on a specific implementation, the mechanisms that interact with the terminal database 240 may be accordingly implemented to facilitate appropriate communications with different storages of the terminal database 240.

The information analysis mechanism 250 analyzes information from different sources to derive, for example, statistics related to specific tanks or the operations of the entire terminal. The information analysis mechanism 250 may retrieve information stored in the data storage 240a of the terminal database when needed. It may also receive information directly from the PDICM 230. Alternatively, it may also use information in its analysis based on both information previously stored in the terminal database 240 and the information directly from the PDICM 230.

The analysis performed at the information analysis mechanism 250 may include computation of receipt related data according to lifting information from different tanks. It may also include calculation of inventories with respect to different products or different suppliers. Such data may be generated to facilitate future tasks such as report generation, product distribution projection, or replenishment scheduling forecast. The analyzed result from the information analysis mechanism 250 can also be stored back to the terminal database 240, if needed. Such results may also be sent to the TRGM 260 for report generation purposes.

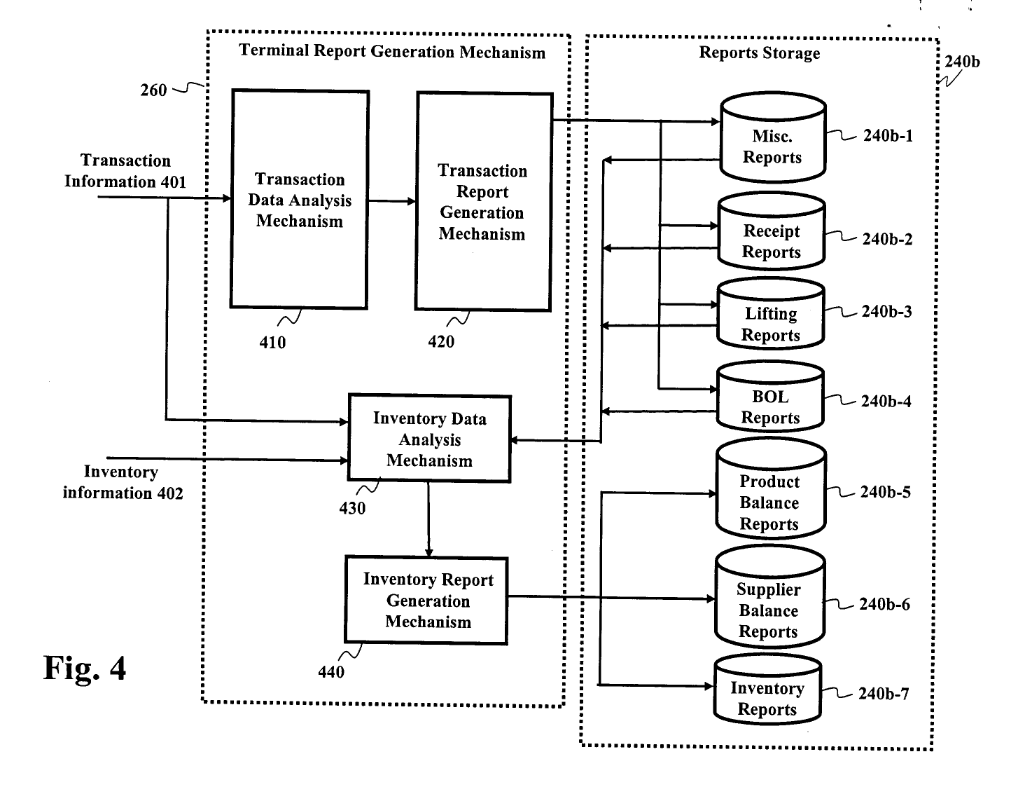

The TRGM 260 is responsible for generating terminal reports or reports related to different aspects of the business operations at the underlying terminal (i.e., the LPDT 110a). The TRGM 260 may create reports based on information from different sources. For example, it may use information stored in the data storage 240a or it may use the analytical results generated by the information analysis mechanism 250. It is also possible that the TRGM 260 utilizes prior reports to create new reports. For instance, to generate an annual report, all monthly reports generated previously and stored in the reports storage 240b may be retrieved and manipulated so that the annual report can be generated. Details related to the TRGM 260 are described with reference to FIGS. 4, 5, and 9.

The communication mechanism 270 can be implemented in various ways for enabling required communications between the LPDT 1 110a and different parties. These various ways include, but are not limited to, conventional telephony devices, wireless arrangements and other telecommunication devices. For example, the communication mechanism 270 may facilitate interactions via the Internet through narrowband (e.g., telephone lines) or broadband (e.g., cable connections, DSL, optical, broadband wireless, etc.) networks. The communication mechanism 270 may facilitate either wired or wireless communication modes. Through the communication mechanism 270, the LPDT 1 110a may send product distribution related information to the liquid product management mechanism 120 and receive, from the same, information such as distribution projection and product scheduling forecasts.

FIG. 4 schematically depicts an exemplary functional block diagram of the TRGM 260 in relation to the reports storage 240b, according to an embodiment of the inventions. The TRGM 260 includes a transaction data analysis mechanism 410, a transaction report generation mechanism 420, an inventory data analysis mechanism 430, and an inventory report generation mechanism 440. The TRGM 260 creates reports related to various aspects of the business transactions conducted at the terminal. As described above, terminal reports may include, but are not limited to, reports regarding lifting, receipts, inventory, product and/or supplier balance, bill of lading, and other miscellaneous aspects of underlying transactions.

To create transaction related reports, the transaction data analysis mechanism 410 takes transaction information 401 as input, which is either retrieved from the data storage 240a or sent from the PDICM 230 (see FIG. 2). Such information may be associated with readings from different tanks at different times, describing transactions at those tanks. Transactions conducted at each tank may necessarily include both incoming as well as outgoing product flows. For example, when a common carrier delivers a liquid product to a tank at an LPDT, it constitutes a transaction (incoming flow). Alternatively, when a customer lifts a certain product at the same tank of the LPDT, it also constitutes a transaction (outgoing flow).

Tank readings associated with a transaction conducted at a particular tank of an LPDT may be recorded, gathered, stored, and used to derive new information or to create reports. For example, tank readings related to incoming product deliveries from a particular common carrier within a one month period may be aggregated and used to generate a monthly receipt report for the common carrier. Similarly, tank readings related to outgoing product liftings by a particular customer within a one-month period may be used to generate a lifting report, which may be further used to generate a billing statement.

The transaction information 401 includes information related to transactions (both incoming and outgoing) at all tanks of an LPDT. Readings from a particular tank may be gathered in an order such as a chronological order. Incoming and outgoing transactions may be interleaved in such gathered readings. That is, while such information is useful in describing different aspects of the business operations at an LPDT, it may need to be processed prior to being used for different purposes. For instance, to generate a receipt report for a particular common carrier, only such tanks readings related to the deliveries performed by the common carrier should be used. Pre-processing performed on the transaction information 401 depends on how such information is to be used. The transaction data analysis mechanism 410 is responsible for processing the transaction information 401 in such a way that facilitates the transaction report generation mechanism 420.

The transaction data analysis mechanism 410 may perform certain data manipulation or analysis to produce results that are useful in generating different transaction related reports. For example, the transaction data analysis mechanism 410 may simply sort or re-shuffle the received transaction information 401 to generate information that is in a desired form according to the nature of the reports to be generated. Individual items in the transaction information 401 may also be extracted and further aggregated to satisfy the needs of a report. In addition, the transaction data analysis mechanism 410 may also derive new information (e.g., certain statistics) based on the input transaction information 401 and then supply such derived new information to the transaction report generation mechanism 420 to generate certain reports.

Results from the transaction data analysis mechanism 410 are used by the transaction report generation mechanism 420 for creating different transaction related reports. Such reports may include receipt reports, lifting reports, BOL reports, or other miscellaneous reports. The transaction report generation mechanism 420 may further include different sub-mechanisms (not shown in FIG. 4), each of which is responsible for generating a particular type of report. Different sub-mechanisms of the transaction report generation mechanism 420 may be designed in a modular fashion so that when the needs change, the transaction report generation mechanism 420 may be adapted to generating different reports.

Transaction related reports generated by the transaction report generation mechanism 420 may be sent to other parties (e.g., to the liquid product management mechanism 120 via the communication mechanism 270 depicted in FIG. 2) or stored for subsequent use. As described above, terminal reports may be stored in the reports storage 240b. For each different type of report, the reports storage 240b may provide a separate storage with a distinct category label. As illustrated in FIG. 4, for example, transaction reports related to receipts may be stored under a category label “receipt reports” (i.e., 240b-2); reports related to liftings may be stored under a category label “lifting reports” (i.e., 240b-3); reports related to bills of lading may be stored under a category label “BOL reports” (i.e., 240b-4); reports related to other miscellaneous aspects of transactions may be stored under a catch-all category label “misc. reports” (i.e., 240b-1).

In a similar fashion, the inventory data analysis mechanism 430 and the inventory report generation mechanism 440 create inventory related reports based on, for example, both transaction information 401 and inventory information 402. The inventory data analysis mechanism 430 takes the transaction information 401 as well as inventory information 402 as input (either retrieved from the data storage 240a or received from the PDICM 230 (see FIG. 2)) and then performs certain data manipulation or analysis to produce results that are required in generating different inventory related reports. The data analysis performed may depend on the needs of different reports to be created.

Results from the inventory data analysis mechanism 430 are sent to the inventory report generation mechanism 440 to create inventory related reports, including inventory reports, product balance reports, supplier balance reports, or other inventory related reports describing miscellaneous aspects of the inventory. Once generated, inventory related reports may be sent to other parties (e.g., to the liquid product management mechanism 120 via the communication mechanism 270 depicted in FIG. 2) or stored in the reports storage 240 for future use. Separate storage space and labels may be provided for different types of inventory related reports. For instance, reports related to product balance may be stored under a category label “product balance reports” (i.e., 240b-5); reports related to supplier balance may be stored under a category label “supplier balance reports” (i.e., 240b-6); reports related to inventories of products may be stored under a category label “inventory reports” (i.e., 240b-7); reports related to other miscellaneous aspects of inventory transactions may be stored under a category label “misc. reports” (i.e., 240b-1).

All terminal reports may be automatically generated according to some predetermined schedules (e.g., daily, weekly, monthly, or annually). Regularly generating reports may be part of the business operation at each LPDT. Reports may also be generated based on demand. Such demand may come from different parties with which an LPDT interacts. For instance, a common carrier may request an LPDT to send a common carrier receipt report in between regular issuance of such reports. The liquid product management mechanism 120 may also demand a terminal report in order to, for example, satisfy a request from an executive. A customer may do the same yet for a different type of report. Such requests may be made to an LPDT through a network connection enabled by the communication mechanism in the LPDT (e.g., 270 n FIG. 2).

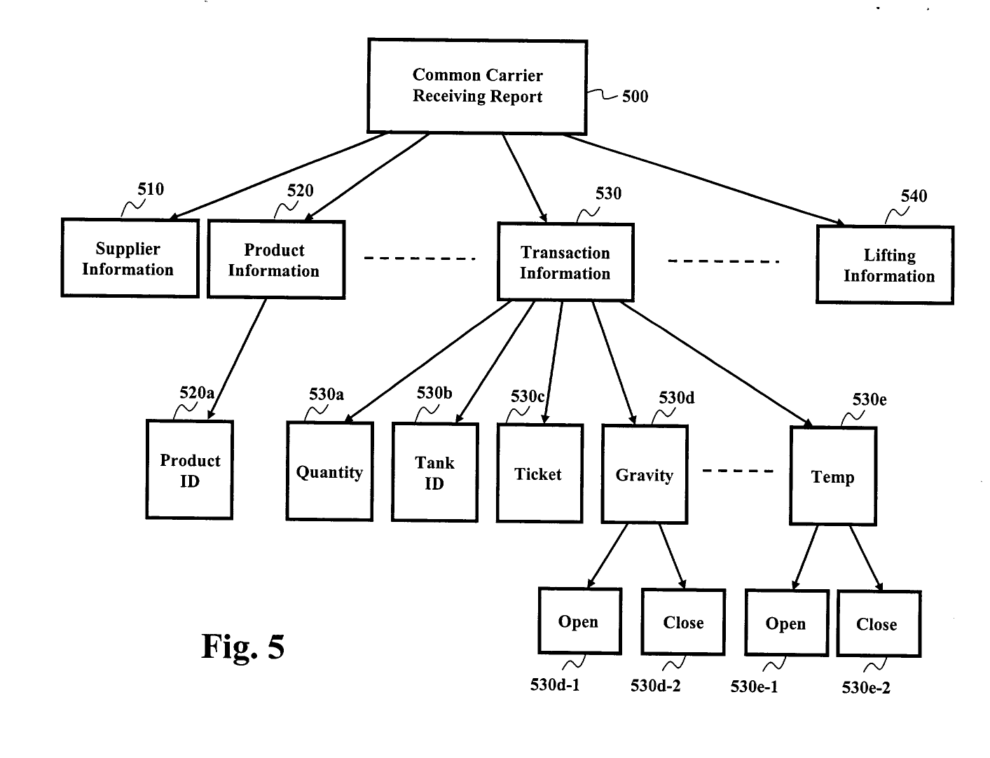

Different types of information or different combinations thereof may be used to generate different terminal reports. FIG. 5 illustrates an exemplary construct of a common carrier receiving report 500 (in the category of receipt reports), according to an embodiment of the inventions. This exemplary receiving report may be generated with respect to a particular common carrier. It contains information describing different aspects of transactions associated with the common carrier. For example, with respect to each transaction, it may include, but is not limited to, supplier information 510, product information 520, . . . , transaction information 530, . . . , and lifting information 540. Each of those different types of information may further include more detailed data. For instance, each product transacted may be identified using a product ID 520a, each transaction may be further described by a quantity 530a, a tank ID 530b identifying a specific tank where the transaction occurred, a ticket 530c associated with the transaction, readings associated with the specific tank such as the gravity level (530d) and temperature (530e) at the time the tank was open for the transaction (i.e., open gravity level 530d-1 and open temperature 530e-1) and at the time the tank was closed at the end of the transaction (i.e., close gravity level 530d-2 and close temperature 530e-2).

Terminal reports may serve various purposes. Some may be generated for the sole purpose of maintaining business records, some may be sent to common carriers, and some may be used by the liquid product management mechanism 120 for centralized management tasks such as billing, product projection, inventory scheduling, and other management tasks. The LPDTs 110 may be in close contact with the liquid product management mechanism 120 so that the liquid product management mechanism 120 is continuously aware of the business operation status of different LPDTs.

The liquid product management mechanism 120 can also interact with other entities to conduct, for example, centralized business transactions and management. For instance, the liquid product management mechanism 120 may perform billing (to customers) based on lifting reports from the LPDTs 110. It may also perform product projection based on both the inventory reports and lifting reports from the LPDTs 110. Based on the projection, it may further forecast the replenishment scheduling and calculate recommended order batch sizes for products based on the forecast to maintain the inventory at different LPDTs at desirable levels.

The liquid product management mechanism 120 may also carry out actions to comply with different governmental agency regulations. For example, it may regularly generate certain reports required by governmental regulations and supply such reports to relevant agencies. It may also send instructions to the LPDTs 110 in order to enforce governmental regulations. The liquid product management mechanism 120 may also interact with different suppliers to, for example, place orders and accordingly inform relevant LPDTs so that arrangements may be made between those LPDTs and common carriers to deliver the ordered products from the suppliers to these LPDTs. In addition, it may interact with the executive management 190 (e.g., executives of the company) so that business operational information is communicated to the management in a timely fashion.

FIG. 6 schematically depicts an exemplary functional block diagram of the liquid product management mechanism 120, according to an embodiment of the inventions. The liquid product management mechanism 120 includes a communication mechanism 610, a central database 615, an information processing mechanism 620, a report generation mechanism 625, executive management related mechanisms (a terminal management mechanism 630 and a business management mechanism 635), accounting related mechanisms (an accounting management mechanism 640 and a billing mechanism 645), scheduling related mechanisms (an inventory management mechanism 650 and a scheduling mechanism 655), and regulation compliance related mechanisms (a regulation compliance mechanism 660 and an agency reporting mechanism 665).

The communication mechanism 610 is capable of facilitating the interactions between the liquid product management mechanism 120 and other entities. The interactions with different parties may be conducted in the same or different communication channels through different network platforms. For example, the communication mechanism 610 may facilitate interactions via the Internet through narrowband (e.g., telephone lines) or broadband networks (e.g., cable connections). The communication mechanism 610 may also facilitate wired or wireless communication modes. That is, the communication mechanism 610 supports communications through a generic network such as a PSTN, an intranet, the Internet, a proprietary network, or a wireless network.

Through the communication mechanism 610, information from the LPDTs 110, including both raw information and terminal reports, may be stored in the central database 615. Such input may also be sent to the information processing mechanism 620 so that new information may be derived based on the input. Such newly derived information may be fed to the report generation mechanism 625 or stored in the central database 615 for future use.

The report generation mechanism 625 creates various reports, including reports for executives related to overall business operations, reports that may be used to estimate product projection and replenishment scheduling, and reports that may be used to perform accounting and other management related tasks. Such generated reports may be stored in the central database 615 or may be sent to relevant parties such as executives.

Reports may be generated according to a pre-determined schedule (e.g., daily, weekly, or monthly) or based on demand. For example, an executive may request for a particular report. Such a demand may be received via the communication mechanism 610 and forwarded to the information processing mechanism 620. By analyzing the request, the information processing mechanism 620 instructs the report generation mechanism 625 in terms of which report to be created for whom. Based on such instructions, the report generation mechanism 625 may retrieve relevant data from the central database 615 and create the requested report using the retrieved data. The report is then sent to the requester via the communication mechanism 610.

The terminal management mechanism 630 is responsible for management issues related to the terminals. It may interact with the LPDTs 110 (through the communication mechanism 610) to receive information, to send information, or to instruct different LPDTs on different business operational matters. For instance, the terminal management mechanism 630 may inform an LPDT when certain orders are placed to replenish the inventory at the LPDT. The business management mechanism 635 may be responsible for overall centralized business management tasks.

The accounting management mechanism 645 may handle accounting matters. It may interact with the billing mechanism 640 to achieve various billing related tasks. The inventory management mechanism 655 may oversee inventory at different LPDTs. According to information regularly gathered from the LPDTs, the inventory management mechanism 655 may project the product distribution and then accordingly forecast the scheduling of product orders so that the inventory at LPDTs can be maintained at desirable levels. The scheduling mechanism 650 may be responsible for matters related to product scheduling. For example, it may interact with suppliers to place orders according to the forecast from the inventory management mechanism 655.

The regulation compliance mechanism 665 may be designed to provide means to monitoring relevant laws and governmental regulations related to liquid products and distributions and to oversee matters related to the compliance with relevant laws and regulations. For example, it may observe applicable federal and state laws related to tax or regulations related to environmental protections. It may also observe governmental requirements such as reporting requirements and instruct the agency reporting mechanism 660 to comply with such requirements. The agency reporting mechanism 660 may generate different reports in compliance with applicable laws and regulations and send such reports to appropriate agencies at required times.

The liquid product management mechanism 120 may be a distributed system. That is, its different sub-mechanisms may be located at different geographical locations, including different offices, cities, states, or even different countries. For example, the accounting department that uses the accounting and the billing mechanisms (645 and 640) may be at a location that is different from the location of the regulation compliance office that uses the regulation compliance mechanism 665 and the agency reporting mechanism 660. Different parts of a company may use different sub-mechanisms yet they may all share the information stored in the central database 615.

The central database 615 may include various information storages and support effective retrieval of the stored information. It may include separate storages (not shown) for data and reports (similar to the terminal database 240). One or more data storages may be designated to store raw information received from different LPDTs. Such raw data may be used by various mechanisms in the liquid product management mechanism 120 to perform different tasks. Similarly, one or more report storages may be designated to store different types of reports that are either received from the LPDTs or generated by its sub-mechanisms.

The central database 615 may be implemented using known techniques or available commercial products. For example, the central database may correspond to a conventional database management system implemented using commercial products such as SQL, Oracle, DB2, Access, or Sybase. The central database 615 may also simply correspond to a data depository implemented using other known techniques such as Excel (a trademark of Microsoft) spreadsheets and with means to access different parts of the stored data.

When different storages are used in the central database 615, they may be implemented using the same or different techniques. For example, a data storage may be realized using Excel spreadsheets and a report storage may be implemented based on database techniques. Different storages may also reside on the same or different physical devices. For instance, Excel spreadsheets received from different LPDTs may be stored on a server that is designated to data analysis and report generation. In the meantime, reports, either received from the LPDTs or generated by the server, may be stored on a separate SQL server.

Different storages may even be located in different physical locations. For instance, the report generating server and the SQL server in the above example may be installed in different cities. That is, the central database 615 may correspond to a distributed database. In this case, the central database 615 may be implemented so that the distributed sites may be synchronized for data integrity and communications among these distributed sites may be encrypted to ensure data security. Depending on a specific implementation, the interfaces of the central database 615, including both other entities outside of the liquid product management mechanism 120 and various sub-mechanisms inside of the liquid product management mechanism 120, may be accordingly designed to facilitate required communications with different parties. For example, it is possible that outside entities communicate with the central database through a web interface via the Internet and internal communications between the central database 615 and various sub-mechanisms are through a proprietary network.

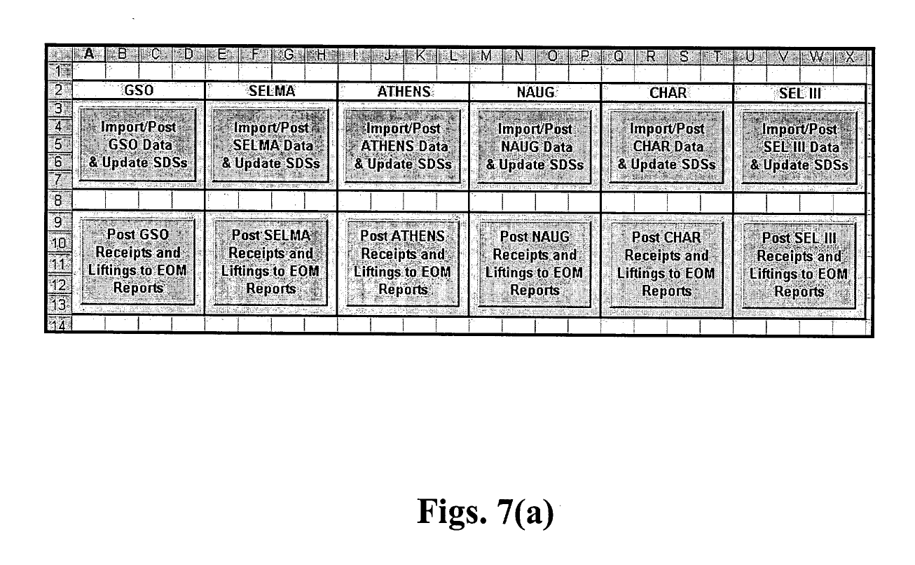

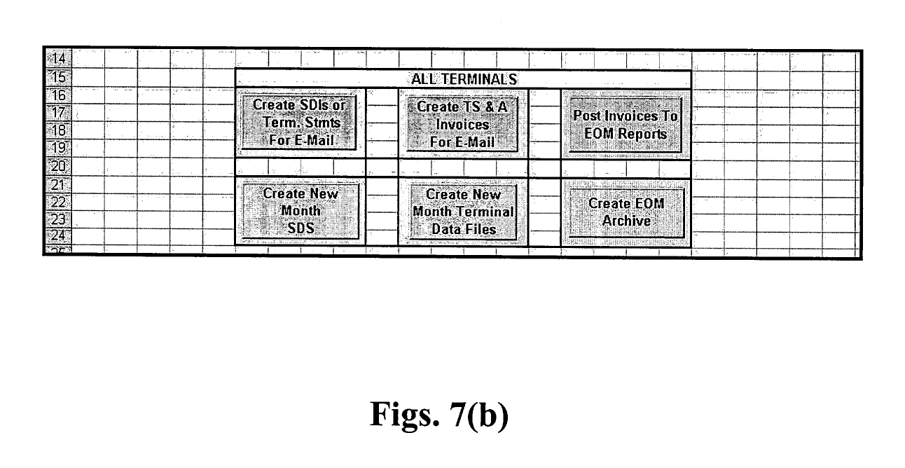

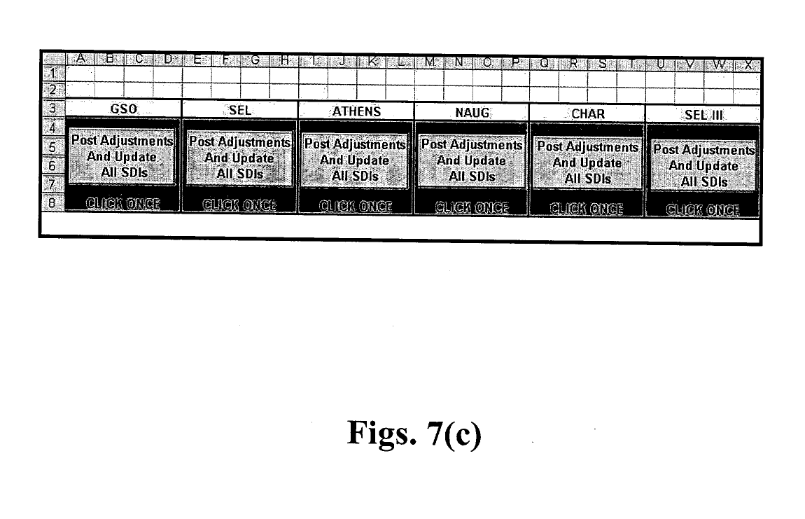

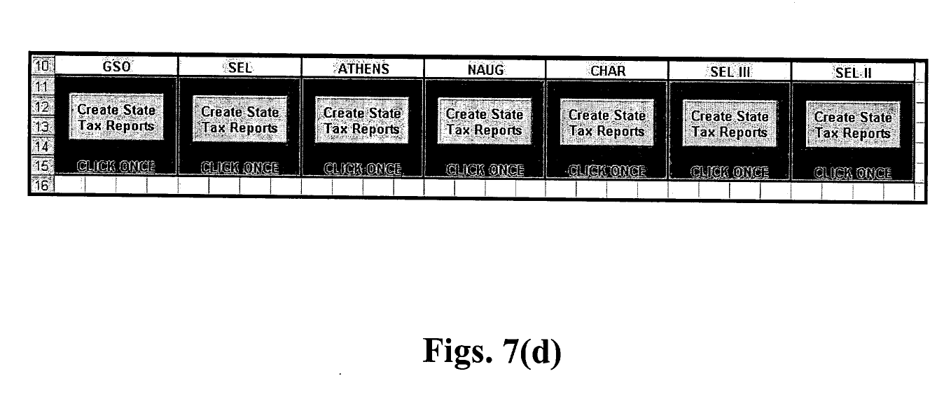

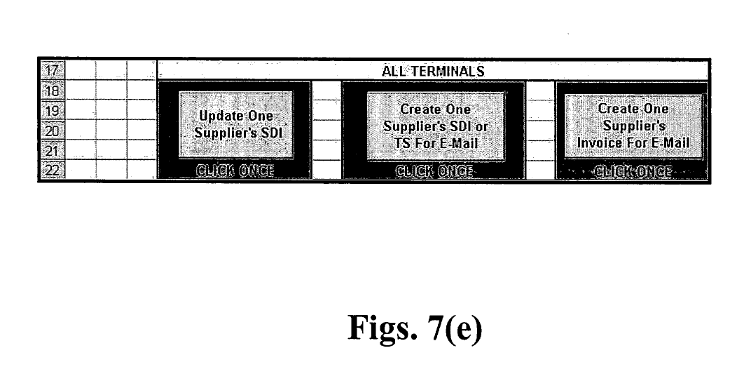

FIGS. 7(a)-7(e) illustrate various user interfaces of an exemplary implementation of different parts of the framework 100 using a spreadsheet platform such as Excel (a trademark of Microsoft Corporation). In a spreadsheet platform setting, user interfaces may be implemented using buttons, through which particular functions may be activated. A specific function associated with a button may be realized via pre-defined macros. When a button is clicked, a macro associated with the button is activated to performed designated functionality. For example, a function may be to create an end of month (EOM) report based on receipt and lifting information loaded from an individual LPDT. In this case, a button corresponding to the function may be created in an interface and is associated with a macro designed to post the receipt and lifting information from a designated LPDT in a worksheet corresponding to the end of month report. In this worksheet, various cells may contain summarized information calculated using macros defined to achieve the computation when the receipt and lifting information is posted.

FIG. 7(a) shows a user interface designed for activating different management capabilities, according to an embodiment of the inventions. In this particular example, there are two groups of buttons, the top group and the bottom group. Each group includes 6 buttons, each of which corresponds to an LPDT. For instance, the left most buttons in both groups correspond to an LPDT named “GSO”, the second an LPDT named “SELMA”, the third an LPDT named “ATHENS”, the fourth an LPDT named “NAUG”, the fifth an LPDT named “CHAR”, and the last an LPDT named “SEL III”.

The top group of buttons is used to activate the importation of terminal data from different LPDTs and then use such imported data to update the supplier daily summary (SDS) reports related to the LPDTs. Such terminal data may include receipt reports, lifting reports, or supplier balance reports. For each terminal, such data may also be used to update, for example, a product balance report to provide a daily balance summary of that terminal.

The bottom group of buttons in FIG. 7(a) is designed to post the receipts and lifting related data from different LPDTs in the end of month (EOM) reports associated with those LPDTs. With this function activated, receipt and lifting information at end of a month at a particular LPDT may be used to compute, for example, positive/negative stocks at the LPDT on a monthly basis.

FIG. 7(b) shows another illustrative user interface used to activate certain central management functions to be applied to all LPDTs, according to an embodiment of the inventions. Exemplary six buttons are shown, each of which can be used to activate a central function to all individual LPDTs. Notice here, with this interface, each selected button will lead to an underlying function to be applied to all LPDTs.

The top left button is used for creating supplier daily inventory (SDI) reports and terminal statements in the form of electronic mails for all LPDTs. When this button is selected, supplier daily summary information at each LPDT is accessed and used to update a supplier daily inventory report associated with the LPDT. The updated SDIs may also be formatted properly and sent to suppliers.

The top middle button is to create throughput storage and additive (TS&A) invoices for all the LPDTs. Each TS&A invoice is created for an individual supplier. Lifting and other information during a specified period may be obtained from each terminal and used to generate the corresponding TS&A invoice.

The top right button is to post invoices to the end of month (EOM) reports of the LPDTs. This function may be designed to access invoices for all suppliers and use such summarized information to generate end of month reports. The bottom left button is to create supplier daily summaries (SDS) for a new month. The bottom middle button is for creating terminal data files for a new month. The bottom right button is for creating end of month (EOM) archives.

FIG. 7(c) shows a user interface for posting adjustments and updating supplier daily inventories at individual LPDTs based on the adjustments, according to an embodiment of the inventions. For each LPDT, there is a separate button to activate the underlying procedure of posting adjustments and use of such adjustment to update the supplier daily inventory at the LPDT. This function facilitates the need to update supplier daily inventory reports whenever supply from certain supplier(s) has been dynamically adjusted. With a given adjustment, this activated function propagates the adjustment to appropriate inventory reports.

FIG. 7(d) illustrates another user interface for activating generation of state tax reports for different LPDTs, according to an embodiment of the inventions. Similarly, for each terminal, there is a separate button to activate. When this function is selected, other interfaces may be activated so that more information may be acquired before a tax report can be generated. For instance, an interface may be designed to acquire a specific period (e.g., a year) for which the tax report is to be prepared and a particular state. With such necessary information, relevant data such as monthly receipts and liftings may be imported from different LPDTs and appropriate tax laws (e.g., tax law of the entered state and federal tax law) may be applied in preparing the requested tax report.

FIG. 7(e) shows an illustrative user interface for activating some central business management functions, according to an embodiment of the inventions. The left button is designed to activate the generation of an overall (single) SDI report across all connected LPDTs. To create this overall report, the activated function may need to retrieve data associated with all the LPDTs and then to generate the requested report based on business transactions across all the LPDTs. The middle button is for creating an overall supplier daily inventory or a terminal statement (an End-of-Month summary/invoice) in the form of an electronic mail. The right button is for creating an overall supplier invoice in an email form.

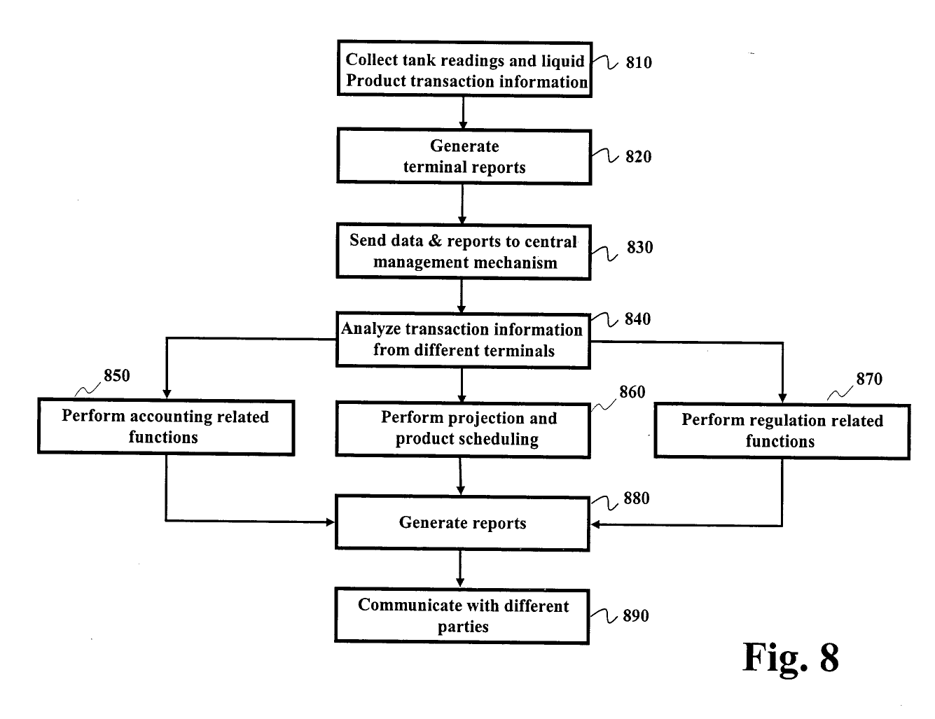

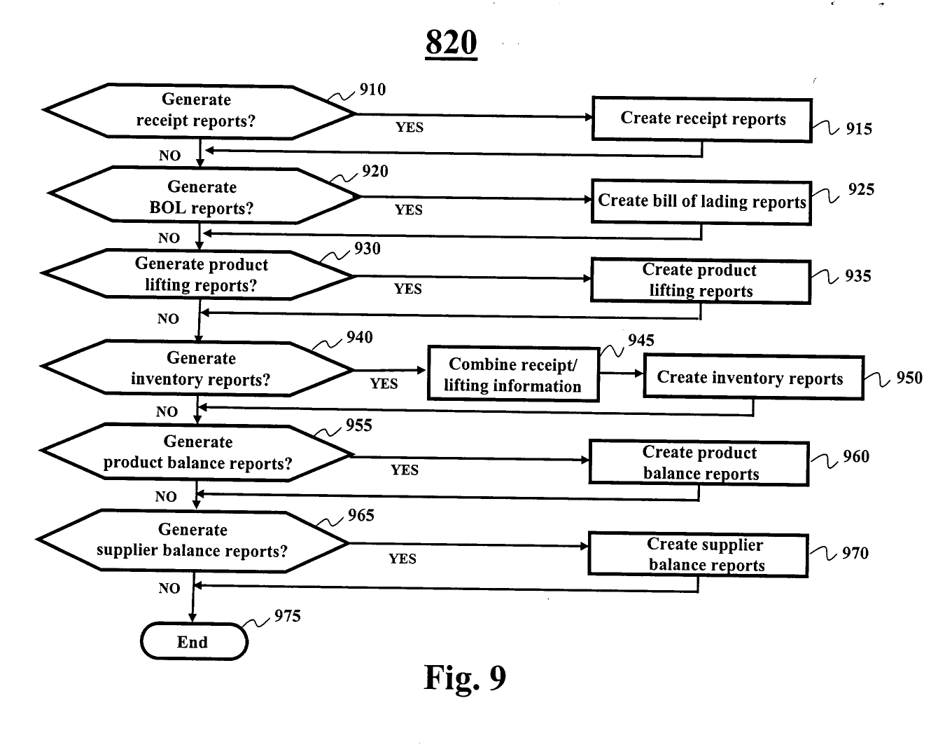

FIG. 8 is a flowchart of an exemplary process, in which a liquid product distribution network is automatically managed, according to an embodiment of the inventions. Various tank readings and other liquid product transaction information associated with different LPDTs are first collected at act 810. Based on the collected data, certain terminal reports are created, at act 820, at individual LPDTs. Details related to generating terminal reports are discussed with reference to FIG. 9. Some of the terminal reports, together with some transaction related information, are sent, at act 830, to the central liquid product management mechanism 120.

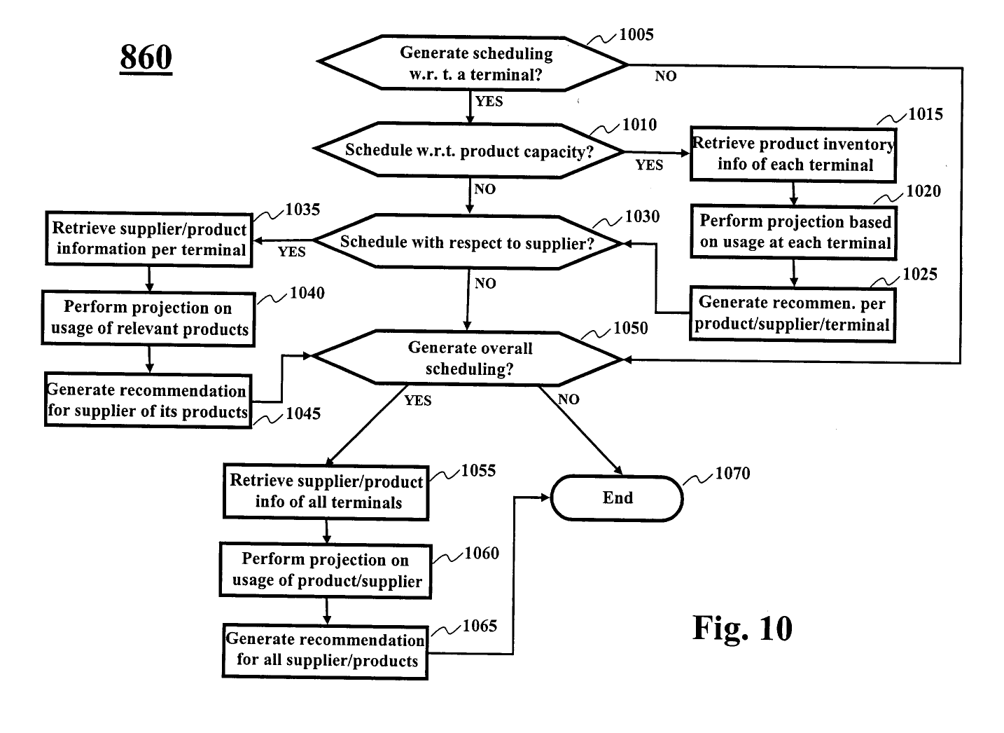

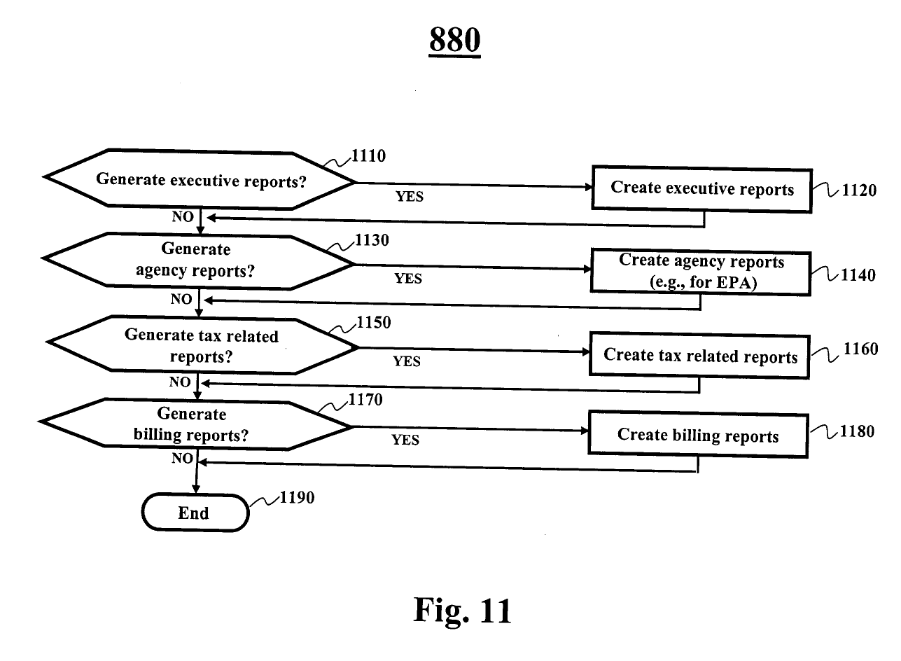

At the central liquid product management mechanism 120, transaction related information from different LPDTs is analyzed at act 840 and used in different management tasks. Accounting tasks are performed at act 850 using different types of information and the combinations thereof. Inventory can be projected, at act 860, and product scheduling may be forecast, at act 870, for either individual LPDTs or across all LPDTs. Details related to inventory projection and product scheduling forecast are discussed with reference to FIG. 10. Different reports may also be generated, at act 880, at the central liquid product management mechanism 120 and subsequently sent to, at act 890, different parties. FIG. 11 describes an exemplary detailed flow of generating reports at the central liquid product management mechanism 120.

FIG. 9 is a flowchart of an exemplary process, in which an LPDT generates various terminal reports, according to an embodiment of the inventions. An LPDT may be designed to support generation of a pre-determined set of terminal reports. However, in operation, it may be configured at a given time to generate a specific set of terminal reports. Different LPDTs may be configured differently, depending on local needs. During business operations, each LPDT performs report generation task based on its configuration at the time.

To generate a particular terminal report, an LPDT may first check whether its current configuration calls for the creation of the terminal report. If the configuration indicates that the category of receipt reports is to be generated, determined at act 910, the TRGM (terminal report generation mechanism) of the LPDT creates various receipt reports at act 915. If the configuration indicates that BOL reports should be generated, determined at act 920, the TRGM creates the BOL reports at act 925. If the configuration indicates that lifting reports should be generated, determined at act 930, the TRGM creates lifting reports at act 935.

If the configuration indicates that inventory related reports should be generated, determined at act 940, the TRGM combines, at act 945, corresponding receipting and lifting information associated with different tanks at the LPDT and creates, at act 950, various inventory related reports. Similarly, if the configuration indicates that product balance reports should be generated, determined at act 955, the TRGM creates product balance reports at act 960. Finally, if the configuration indicates that supplier balance reports should be generated, determined at act 965, the TRGM creates supplier balance reports at act 970 before reaching the end of the inquiry at act 975.

FIG. 10 is a flowchart of an exemplary process, in which liquid product distribution projection and liquid product scheduling forecast are performed, according to an embodiment of the inventions. At the central liquid product management mechanism 120, inventory projection and product scheduling may be performed with respect to different aspects. For example, it may be performed either against each individual LPDT or across all LPDTs. It may also be performed against a particular product capacity at individual LPDTs. Product scheduling may be performed either against a specific supplier or against all suppliers with respect to each product. Depending on how the projection and scheduling is to be performed, the approach used to reach an estimated projection and scheduling may differ.

In FIG. 10, it is first determined, at act 1005, whether the scheduling is to be performed for each terminal or across all terminals. If it is for each individual terminal (or LPDT), it is then determined, at act 1010, whether the scheduling is to be performed with respect to product capacity at a terminal. If it is with respect to the product capacity, the scheduling mechanism first retrieves, at act 1015, with respect to each product, the product inventory information of the underlying terminal and uses such information, in combination with the lifting data related to the product at the terminal, to project, at act 1020, future distribution rate at the terminal. According to such projection, a scheduling forecast is generated, at act 1025, with respect to the product against each supplier for the terminal. Acts 1015, 1020, and 1025 may be repeated for each product distributed at the terminal until all are enumerated.

When the projection and scheduling is to be performed against suppliers, determined at act 1030, information related to each supplier (including the product(s) it supplies) for the terminal is first retrieved at act 1035. Based on such information, future usage of each product supplied by the supplier is projected, at act 1040. A product scheduling forecast against the supplier with respect to each product it supplies to the terminal is then generated at act 1045 based on the projected usage. This process (acts 1035, 1040, and 1045) repeats until all the suppliers (with respect to all the products they supply) for the terminal are processed.

When scheduling is to be performed across all terminals, determined at act 1050, information related to each supplier (including the product(s) it supplies) for all the terminals is first retrieved at act 1055. Based on such information, future usage of each product supplied by the supplier across all terminals is projected, at act 1060. A product scheduling forecast against the supplier with respect to each product it supplies to all terminals is then generated, at act 1065, based on the projected usage of the product across all terminals. This process (acts 1055, 1060, and 1065) repeats until all the suppliers (with respect to all the products they supply) for all the terminals are processed.

FIG. 11 is a flowchart of an exemplary process, in which the report generation mechanism 625 of the liquid product management mechanism 120 generates different reports, according to an embodiment of the inventions. As described above, a report generation mechanism may be designed to support the generation of a set of reports. However, it may be configured at run time to generate a subset of supported reports.

To generate a particular report, the report generation mechanism 625 may first check whether its current configuration calls for the creation of certain reports. If the configuration indicates that executive reports are to be generated, determined at act 1110, the report generation mechanism 625 creates, at act 1120, various executive reports. If the configuration indicates that certain agency reports should be generated, determined at act 1130, the report generation mechanism 625 creates corresponding agency reports at act 1140. If the configuration indicates that tax related reports need to be generated, determined at act 1050, the report generation mechanism 625 generates relevant tax reports at act 1060. Finally, if the configuration indicates that certain billing reports need to be generated, determined at act 1170, the report generation mechanism 625 creates corresponding billing reports at act 1180 before reaching the end of processing at act 1090.

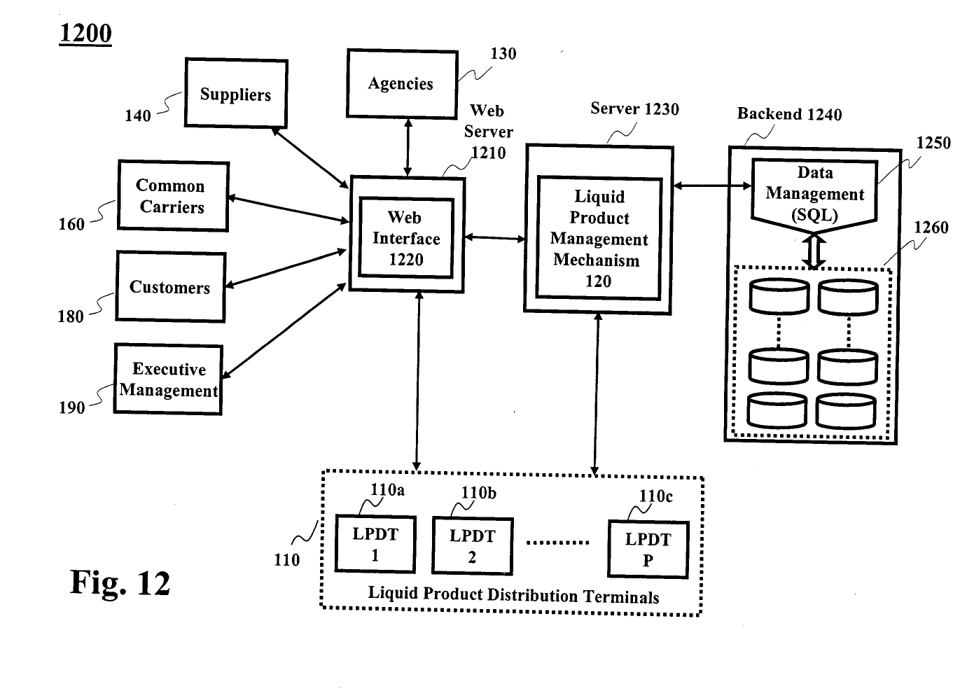

FIG. 12 schematically depicts an exemplary web-based architecture 1200 for liquid product distribution and automated management, according to an embodiment of the inventions. In the architecture 1200, a web server 1210 is included to provide a web interface 1220 that facilitate communications among different parties, including the LPDTs 110, the suppliers 140, the common carriers 160, the customers 180, and the executive management 190. The liquid product management mechanism 120 is deployed on a server 1230 that communicates with the above mentioned parties via the web interface 1220. In addition, the liquid product management mechanism 120 has a backend 1240 that provides data management services 1250.

The data management 1250 may be realized using commercially available systems such as database systems or spreadsheets. Database systems include Oracle/SQL, DB2, Sybase, or Access. The data management 1250 manages one or more data storages 1260 where the data resides and facilitates the needs of the liquid product management mechanism 120 in data storage and retrieval.

The web interface 1220 may provide distinct interfaces and shared interfaces for various communications among different parties. For example, an executive officer may use a privileged communication interface to request the liquid product management mechanism 120 to generate certain reports. Such generated reports may then be posted on a different secure interface so that the requesting executive officer can view the reports. A common carrier may communicate with a particular LPDT, via a separate web interface, to schedule a shipment of a certain product. In addition, either an LPDT or the liquid product management mechanism 120 may acquire updates in different governmental agencies via the web interface 1220. Furthermore, the liquid product management mechanism 120 may communicate with a certain supplier to place an order via another interface provided by the web server 1210.

The liquid product management mechanism 120 may be deployed on the server 1230 as an application. Such an application may be single threaded or possibly multi-threaded, wherein each of the threads may be designated to perform a distinct management functionality. Different threads may run in parallel or they may be synchronized at appropriate times. For example, threads performing monthly business transaction related functions (e.g., billing and governmental reporting) may not be activated until relevant end of month data has been generated.

Such an application may be implemented in a particular programming languages such as Visual Basics, C, C++, or Java. The application may also be implemented in different languages, wherein different parts of the application may be programmed using a programming language that is suitable for the function performed. For instance, the part of the liquid product management mechanism 120 that is responsible for interacting with the SQL data management, C may be used to program the interface. The part of the liquid product management mechanism 120 that is responsible for interacting with the web interface 1220 may be programmed in Java.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the invention described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

What is claimed is:

1. A method, comprising:
collecting liquid product distribution information from a plurality of liquid product distribution terminals, wherein the liquid product distribution information includes lifting information with additive treat rates and receiving information gathered at the liquid product distribution terminals;
analyzing transactions based on liquid product distribution information collected from the liquid product distribution terminals;
performing liquid product distribution projection and liquid product scheduling forecast based on the analysis performed by said analyzing; and
generating at least one report based on the analysis performed based on the liquid product distribution information.

2. The method according to claim 1, wherein the lifting information includes information related to at least one of:
a liquid product with associated additive meter readings indicative of the additive treat rates tracked against target liquid additive calculations required by regulations;
a time at which the liquid product is distributed;
a supplier that suppliers the liquid product; and
a customer who is to receive the liquid product.

3. The method according to claim 2, wherein the information related to the liquid product distributed includes at least one of:
a product identification;
a meter identification identifying a meter from which the product is lifted and the additive meter readings corresponding to the lifted product are obtained;
gallon information associated with the meter.

4. The method according to claim 2, wherein the information related to the customer includes at least one of:
a customer identification identifying the customer; and
a destination information indicating a destination to which the liquid product is distributed.

5. The method according to claim 1, wherein the at least one report includes at least one of:
an executive management report;
a billing report;
a receipt report;
a lifting report;
an inventory report;
a product balance report;
a supplier balance report; and
a bill of lading report.

6. The method according to claim 5, wherein the receipt report includes a common carrier receiving report which comprises:
supplier information;
liquid product information; and
transaction information derived based on the receiving information gathered at the liquid product distribution terminals.

7. The method according to claim 6, wherein the transaction information includes:
quantity information indicating the quantity of the liquid product received;
tank identification representing a tank at which the transaction takes place;
gravity information indicating the gravities associated with the tank when the tank is open and when the tank is closed; and
temperature information indicating the temperature measures associated with the tank when the tank is open and when the tank is closed.

8. The method according to claim 5, further comprising a governmental report generated for a governmental agency according to the regulations of the governmental agency.

9. The method according to claim 8, wherein the governmental agency includes at least one of:
the federal environment protection agency (EPA);
the respective state Department of Environment and Natural Resources (DENR); and
the respective state Department of Revenue.

10. The method according to claim 5, further comprising a tax related report generated in compliance with relevant tax law and/or regulation.

11. The method according to claim 1, wherein said performing comprises at least one of:
performing liquid product lifting projection and liquid product scheduling with respect to each liquid product distribution terminal; and
performing liquid product distribution projection and liquid product scheduling across all the liquid product distribution terminals.

12. The method according to claim 11, wherein said performing with respect to each liquid product distribution terminal comprises at least one of:
scheduling a liquid product with respect to product capacity at a liquid product distribution terminal; and
scheduling the liquid product with respect to each supplier that supplies the liquid product to the liquid product distribution terminal.

13. The method according to claim 12, wherein said scheduling with respect to product capacity for a liquid product distribution terminal comprises:
retrieving inventory information related to the liquid product associated with the liquid product distribution terminal;
projecting the product capacity according to information associated with the liquid product distribution terminal; and
generating a recommended scheduling of the liquid product with respect to each of the suppliers of the liquid product for the liquid product distribution terminal.

14. The method according to claim 12, wherein said scheduling a liquid product with respect to a supplier of the liquid product comprises:
retrieving information relevant to liquid products that are supplied by the supplier to the liquid product distribution terminal;
projecting the usage of the products at the liquid product distribution terminal based on the retrieved information; and
generating a recommended scheduling with respect to the supplier on each of the products supplied by the supplier.

15. The method according to claim 11, wherein said performing liquid product lifting projection and liquid product scheduling across all the liquid product distribution terminals comprises:
retrieving information relevant to each liquid product and each supplier of the liquid product associated with all the liquid product distribution terminals;
projecting the liftings of each liquid product with respect to each supplier of the liquid product based on the retrieved information; and
generating a recommended replenishment scheduling for each liquid product from each supplier, across all the liquid product distribution terminals, based on the projection performed.

16. The method according to claim 1, further comprising:
performing accounting functions based on the liquid product distribution information; and
performing governmental regulation related functions based on the liquid product distribution information.

17. A system, comprising:
a plurality of liquid product distribution terminals capable of receiving a liquid product from a supplier via a common carrier and distributing a product to a customer, wherein the product to the customer is produced based on the received liquid product according to an additive treat rate; and
a liquid product management mechanism capable of managing the liquid product distribution at and among the liquid product distribution terminals and performing liquid product scheduling according to the distribution information collected from the liquid product distribution terminals.

18. The system according to claim 17, wherein each liquid product distribution terminal comprises:
a product distribution information collection mechanism capable of gathering information related to liquid product distribution;
an information analysis mechanism capable of analyzing transactions based on liquid product distribution information collected from the liquid product distribution terminal; and
a terminal report generation mechanism capable of generating a report based on the liquid product distribution information and the analysis performed by the information analysis mechanism.

19. The system according to claim 18, wherein the terminal report generation mechanism comprises:
a transaction report generation mechanism capable of creating a transaction related reports based on transaction data derived from the liquid product distribution information;
an inventory report generation mechanism capable of creating a product inventory related reports based on the transaction data, time dated measurement data, and product inventory information.

20. The system according to claim 19, wherein the transaction related report includes at least one of:
a receipt report;
a lifting report; and
an inventory report.

21. The system according to claim 19, wherein the inventory related report includes at least one of:
an inventory report;
a product balance report;
a supplier balance report; and
a bill of lading report.

22. The system according to claim 18, further comprising a communication mechanism capable of communicating with the liquid product management mechanism and the common carrier.

23. The system according to claim 17, wherein the liquid product management mechanism comprises:
a report generation mechanism capable of generating a report based on liquid product distribution information received from a liquid product distribution terminal;
a management mechanism capable of managing liquid product distribution; and
a scheduling mechanism capable of automatically recommending a replenishment scheduling for liquid products.

24. The system according to claim 23, wherein the management mechanism comprises:
a terminal operations management mechanism; and
a business management mechanism.

25. The system according to claim 23, wherein the scheduling mechanism comprises:
an inventory management mechanism capable of maintaining inventory based on liquid product distribution information from the liquid product distribution terminals; and
a scheduling mechanism capable of performing recommended replenishment scheduling based on inventory information and distribution of liquid products projected according to the liquid product distribution information.

26. The system according to claim 23, further comprising:
an accounting management mechanism capable of performing accounting related functions associated with liquid product distribution; and
a billing mechanism capable of generating billing information to the supplier according to the accounting performed by the accounting management mechanism.

27. The system according to claim 23, further comprising:
a regulation compliance mechanism capable of tracking governmental reporting regulation requirements associated with a relevant governmental agency and complying with the governmental regulations in liquid product distribution management; and
an agency reporting mechanism capable of generating an agency report in compliance with the governmental regulations.

28. The system according to claim 17, further comprising a server capable of providing an interface through which communications can be conducted.

29. The system according to claim 28, wherein the server includes a web server.

30. The system according to claim 28, wherein the interface includes a web-based interface.

31. The system according to claim 25, further comprising an information management backend capable of facilitating information storage and retrieval.

32. The system according to claim 31, wherein the information management backend includes a database management mechanism.

33. The system according to claim 31, wherein the database management mechanism comprises one of:
SQL;
Sybase;
DB2;
Access; and
one or more spreadsheets.

34. The system according to claim 31, wherein the liquid product management mechanism is implemented in a programming language.

35. The system according to claim 34, wherein the programming language includes one of:
Visual Basic;
C;
C++; and
Java.

36. An article comprising a storage medium having stored thereon instructions that, when executed by a machine, result in the following:
collecting liquid product distribution information from a plurality of liquid product distribution terminals, wherein the liquid product distribution information includes lifting information with additive treat rates and receiving information gathered at the liquid product distribution terminals;
analyzing transactions based on liquid product distribution information collected from the liquid product distribution terminals;
performing liquid product distribution projection and liquid product scheduling forecast based on the analysis performed by said analyzing; and
generating at least one report based on the analysis performed based on the liquid product distribution information.

37. The article according to claim 36, wherein the lifting information includes information related to at least one of:
a liquid product with associated additive meter readings indicative of the additive treat rates tracked against target liquid additive calculations required by regulations;
a time at which the liquid product is distributed;
a supplier that suppliers the liquid product; and
a customer who is to receive the liquid product.

38. The article according to claim 37, wherein the information related to the liquid product distributed includes at least one of:
a product identification;
a meter identification identifying a meter from which the product is lifted and the additive meter readings corresponding to the lifted product are obtained;
gallon information associated with the meter.

39. The article according to claim 37, wherein the information related to the customer includes at least one of:
a customer identification identifying the customer; and
a destination information indicating a destination to which the liquid product is distributed.

40. The article according to claim 36, wherein the at least one report includes at least one of:
an executive management report;
a billing report;
a receipt report;
a lifting report;
an inventory report;
a product balance report;
a supplier balance report; and
a bill of lading report.

41. The article according to claim 40, wherein the receipt report includes a common carrier receiving report which comprises:
supplier information;
liquid product information; and
transaction information derived based on the receiving information gathered at the liquid product distribution terminals.

42. The article according to claim 41, wherein the transaction information includes:
quantity information indicating the quantity of the liquid product received;
tank identification representing a tank at which the transaction takes place;
gravity information indicating the gravities associated with the tank when the tank is open and when the tank is closed; and
temperature information indicating the temperature measures associated with the tank when the tank is open and when the tank is closed.

43. The article according to claim 40, the instructions, when executed by a machine, further result in generating a governmental report for a governmental agency according to the regulations of the governmental agency.

44. The article according to claim 43, wherein the governmental agency includes at least one of:
the federal environment protection agency (EPA);
the respective state Department of Environment and Natural Resources (DENR); and
the respective state Department of Revenue.

45. The article according to claim 40, the instructions, when executed by a machine, further result in generating a tax related report in compliance with relevant tax law and/or regulation.

46. The article according to claim 36, wherein said performing comprises at least one of:
performing liquid product lifting projection and liquid product scheduling with respect to each liquid product distribution terminal; and
performing liquid product distribution projection and liquid product scheduling across all the liquid product distribution terminals.

47. The article according to claim 46, wherein said performing with respect to each liquid product distribution terminal comprises at least one of:
scheduling a liquid product with respect to product capacity at a liquid product distribution terminal; and
scheduling the liquid product with respect to each supplier that supplies the liquid product to the liquid product distribution terminal.

48. The article according to claim 47, wherein said scheduling with respect to product capacity for a liquid product distribution terminal comprises:
retrieving inventory information related to the liquid product associated with the liquid product distribution terminal;
projecting the product capacity according to information associated with the liquid product distribution terminal; and
generating a recommended scheduling of the liquid product with respect to each of the suppliers of the liquid product for the liquid product distribution terminal.

49. The article according to claim 47, wherein said scheduling a liquid product with respect to a supplier of the liquid product comprises:
retrieving information relevant to liquid products that are supplied by the supplier to the liquid product distribution terminal;
projecting the usage of the products at the liquid product distribution terminal based on the retrieved information; and
generating a recommened scheduling with respect to the supplier on each of the products supplied by the supplier.

50. The article according to claim 47, wherein said performing liquid product lifting projection and liquid product scheduling across all the liquid product distribution terminals comprises:
retrieving information relevant to each liquid product and each supplier of the liquid product associated with all the liquid product distribution terminals;
projecting the liftings of each liquid product with respect to each supplier of the liquid product based on the retrieved information; and
generating a recommended replenishment scheduling for each liquid product from each supplier, across all the liquid product distribution terminals, based on the projection performed.

51. The article according to claim 36, the instructions, when executed by a machine, further result in:
performing accounting functions based on the liquid product distribution information; and
performing governmental regulation related functions based on the liquid product distribution information.
